(19) United States
(12) Patent Application Publication
(10) Pub. No.: US 2013/0126649 A1
(43) Pub. Date: May 23, 2013

(54) Ring for Grinding Mill

(71) Applicants: Brian Tallent, Franklin, TN (US); Armond Groves, Nashville, TN (US)

(72) Inventors: Brian Tallent, Franklin, TN (US); Armond Groves, Nashville, TN (US)

(73) Assignee: Magotteaux International S.A., Vaux-Sous-Chevremont (BE)

(21) Appl. No.: 13/637,477

(22) PCT Filed: Mar. 31, 2010
(86) PCT No.: PCT/EP2010/054278

§ 371 Date: Feb. 6, 2013

(51) Int. Cl. B02C 15/00; B02C 15/02

(52) U.S. Cl. CPC B02C 15/003; B02C 15/02
USPC 241/131; 241/274

(57) ABSTRACT

The present invention is related to a segmented grinding ring for centrifugal vertical roller mills comprising a plurality of segments.

### FIELD OF THE INVENTION

The present invention is related to a segmented grinding ring for centrifugal vertical roller grinding mills or pendulum grinding mills. In particular, the present invention relates to an improved segmented grinding ring with higher wear resistance.

### STATE OF THE ART

The prior art discloses various grinding mill types. A typical configuration of a vertical roller centrifugal grinding mill comprising a grinding ring cooperating with a plurality of centrifugally operating grinding rollers is disclosed in the document U.S. Pat. No. 4,022,387 (see FIG. 1). To avoid extensive comments on how such a type of grinder works, this document is hereby incorporated by reference in the present description.

The document U.S. Pat. No. 3,337,142 discloses a roller grinding mill apparatus for comminuting solid materials such as mineral products, clays, coal or metal granules. This apparatus includes a monolithic annular grinding ring, a central rotating member and a plurality of rolls hung from the central rotating member and moved outwardly toward the grinding ring under the influence of centrifugal force.

The grinding pressure can be adapted through the pressure of a liquid as well as through the rotational speed of the central member.

The document EP 1 365 863 A1 describes the same type of grinder.

The above-mentioned grinders comprise monolithic non-segmented grinding rings, which are manufactured in one piece and which are therefore difficult to replace. Furthermore, it is difficult to reinforce them against wear with very hard ceramic particles such as metallic oxides (Al₂O₃, ZrO₂, Al2O₃-ZrO₂ composites) or metallic carbides (WC, TiC, SiC), borides (B₄C) or nitrides (BN, Si₃N₄) in the manufacturing process. Monolithic grinding rings, once worn, are reinforced by cladding using carbides. This operation is nevertheless difficult and time consuming.

Ceramic particles have intrinsically different heat dilatation coefficients than iron-based cast metals and are therefore difficult to embed in metal matrixes without risk of tears due to differential cooling of the materials.

Specific reinforcement particles suitable to be used for a segmented grinding ring according to the present invention are disclosed in US RE 39,998. This document discloses a composite wear component produced by casting and consisting of a metal matrix whose working face or faces include inserts which have a very high wear resistance, said inserts consisting essentially of ceramic composites comprising 20 to 80% of Al₂O₃ and 80 to 20% of ZrO₂, the inserts being impregnated by liquid metal during the casting. This document is hereby incorporated by reference in the present description.

The documents U.S. 7,513,295 B2 and U.S. 2005/0072545 A1 disclose wear parts with reinforcing ceramic particles obtained by a self-propagating heat-synthesis (SHS) via inserts ignited and impregnated by the casting of the liquid metal. This type of technology can also be considered for the ceramic reinforcement of segmented grinding rings. This document is hereby incorporated by reference in the present description.

### AIMS OF THE INVENTION

The present invention aims to provide a segmented grinding ring for grinding mills overcoming the drawbacks of the monolithic grinding rings of the prior art.

The present invention aims in particular to provide a segmented grinding ring making possible an individual replacement of each segment and reducing therefore substantially the downtime and the maintenance costs of a grinding mill comprising a segmented ring according to the invention.

The present invention aims further to provide a segmented grinding ring with an improved wear resistance and therefore a substantially higher lifetime.

### SUMMARY OF THE INVENTION

The present invention discloses a segmented grinding ring for centrifugal vertical roller mills comprising a plurality of segments.

Preferred embodiments of the present invention comprise at least one, or an appropriate combination of the following features:
the segments of the segmented grinding ring comprise a composite structure on their working face, said composite structure comprising ceramic particles embedded in a cast metal;
the thickness of the composite structure comprising the embedded ceramic particles is at least 10 mm, preferably at least 20 mm;
the thickness of the composite structure comprising the embedded ceramic particles is between 20 and 30 mm;
the composite structure comprising the embedded ceramic particles is a honey comb structure;
the ceramic particles are selected from the group consisting of metallic oxides, metallic carbides, borides and nitrides;
the ceramic particles are selected from the group consisting of Al₂O₃, ZrO₂, Al₂O₃—ZrO₂ , WC, TiC, SiC, B₄C, BN and Si₃N₄;
the ceramic particles are spheroid ceramic grains of a size between 0.5 to 6 mm, said grains comprising an alumina-zirconia composite comprising 20 to 80 wt % ZrO₂ and 80 to 20 wt % Al₂O₃;
the ceramic particles are spheroid ceramic grains of a size between 1 and 5 mm, said grains comprising an alumina-zirconia composite comprising 35 to 45 wt % ZrO₂ and 65 to 55 wt % Al₂O₃;
the grinding ring presents 3 to 12 segments, preferably 4 to 6 segments;
the segments comprise a recess for the introduction of a positioning pin located between each couple of segments, said segments being maintained connected to each other by vaulting effect;
the segments comprise hangers to maintain the segments during the mounting operation;
the ring comprises shims to close possible gaps between the segments after the mounting operation.

The present invention further discloses a centrifugal vertical roller mill comprising a segmented grinding ring according to the invention.

### BRIEF DESCRIPTION OF THE DRAWINGS

FIG. 1 represents a roller grinding mill of the state of the art disclosed in U.S. Pat. No. 4,022,387, showing in which configuration a monolithic grinding ring (38) with its surface (39a) is arranged on a support (10) and cooperates with the centrifugal grinding rollers (10) for grinding operations.

FIG. 2 represents a three-dimensional view of the segmented grinding ring, in this example with 6 segments, according to the invention.

FIG. 3 represents a top view of the segmented grinding ring according to the invention.

FIG. 4 represents a section view of the segmented grinding ring according to the invention with reinforcing ceramic particles (in grey).

FIG. 5 represents a detailed section view of the reinforced part of the grinding ring with reinforcing ceramic particles embedded in the metal matrix.

FIG. 6 represents the principle of the casting of a segment of the ring according to the invention with a reinforced part comprising an insert with ceramic particles or with a powder precursor of ceramic particles.

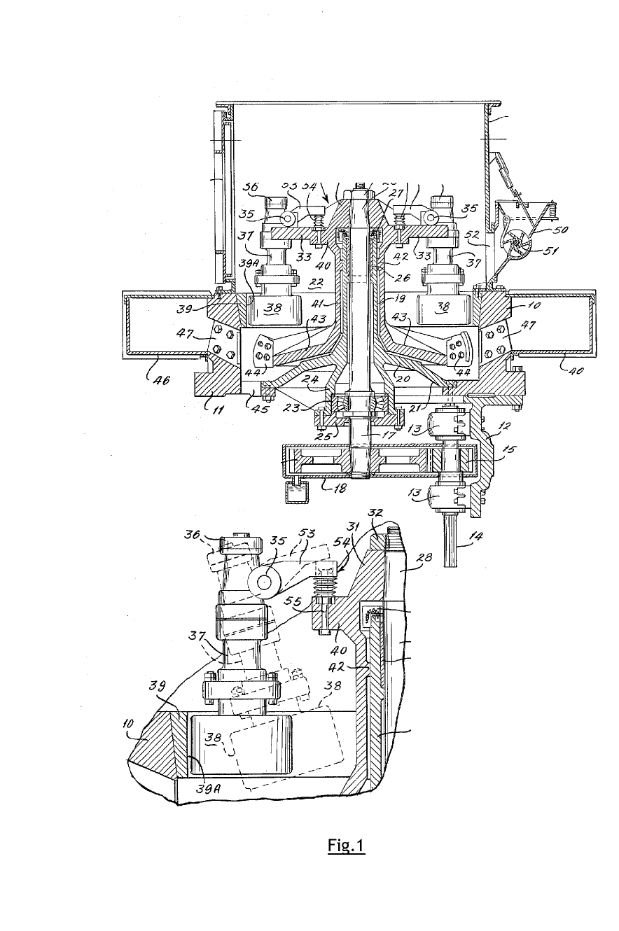

### DETAILED DESCRIPTION OF THE INVENTION

The present invention is related to segmented grinding rings for vertical centrifugal mills. In this type of mills, also called pendulum roller mills, two or more rollers using centrifugal force grind various materials by rolling on a circular ring. This machine is frequently used to feed the coal burners of power plant stations.

The segmented grinding ring of the present invention comprises multiple cast segments which are vaulted together by vaulting effect using pin rods and shims to form a continuous ring. The number of segments varies generally between 3 and 12 and preferably between 4 and 10. The diameter of the assembled grinding ring according to the invention is dependent on the type of the grinding mill and varies roughly between 1 and 4 meters, preferably between 1.5 and 3 meters. A segmented grinding ring enables the manufacturability of the segments in a much harder cast material and in particular in composite material, which thus lengthens the lifetime and improves the performance of the grinding ring.

The casting of smaller pieces allows the embedding or the preparation in situ of hard ceramic particles such as, without being limitative, metallic oxides (Al₂O₃, ZrO₂, Al₂O₃—ZrO₂ composites) or metallic carbides (WC, TiC, SiC), borides (B₄C) or nitrides (Si₃N₄). To hold ceramic particles or a powder precursor of this particles (in the case of a SHS synthesis) in place, an insert of said particles is prepared and placed in the mould before the cast metal is poured on it. The cast metal impregnates the porous ceramic structure and builds a very wear resistant composite structure on the working side of the grinding ring segment.

This type of composite structure would be difficult to achieve on a monolithic grinding ring, because the casting as such is often too large and it is always difficult to hold a ceramic insert along a vertical surface when pouring the metal. Furthermore, on such a big monolithic block, the risk of tears/breakage during the metal solidification is too high with the risk of final rejection of the casting.

Additionally, the segmented ring according to the invention allows a substantial reduction of the downtime when replacing the ring, since it is not necessary anymore to remove the entire upper mill housing when installing or replacing the one-piece fabricated ring according to the prior art. An individual replacement of each segment becomes possible via the existing mill door (manhole).

The segmented ring according to the present invention offers in particular the advantages of supplying a grinding ring comprising reinforced working faces with high-performance wear-resistant composite material as compared to classical monolithic rings with weld overlay. This improves the lifetime of the ring by two or three, maintains the grinding profile much longer and thus improves the performance of the mill and reduces the operating and maintenance costs.

### DESCRIPTION OF A PREFERRED EMBODIMENT OF THE INVENTION

Non-reinforced individual segments for the grinding ring of the present invention can be cast according to classical methods well known by those skilled in the art.

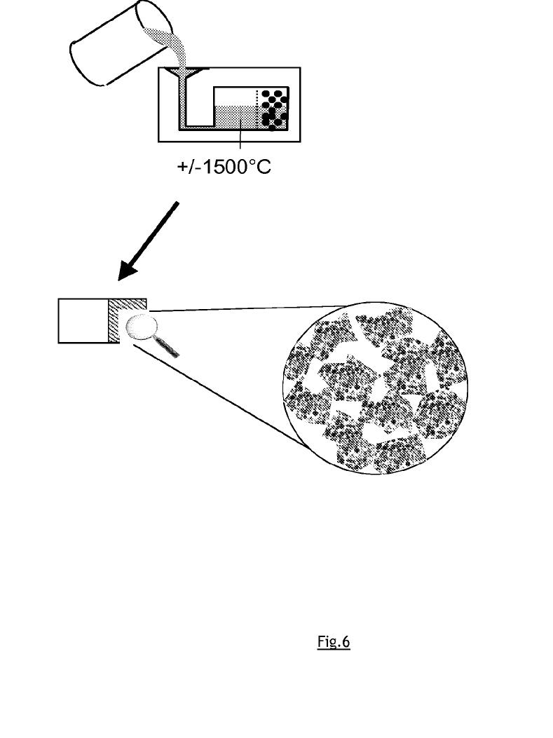

For the preparation of a reinforced individual segment for the grinding ring according to the invention, the working face of the segment is reinforced in depth with ceramic particles. The thickness of the reinforced layer is generally higher than 10 mm, preferably higher than 20 mm and generally situated between 10 and 50 mm, preferably between 20 and 30 mm. Usually inserts of porous ceramic pads of about 25 mm thickness are placed in the cast mould on the working face of a segment followed by the pouring of iron-based cast metal in the mould. The principle of this operation is represented in FIG. 6. The ceramic pad is obtained by the agglomeration of ceramic granules of a size between 0.5 and 6 mm, preferably between 1 and 5 mm. Such an agglomeration can occur in a press or with additional mineral glue. The ceramic pad can present any geometrical configuration, but it is always adapted to the depth of the working face to be reinforced.

During the cast operation, the ceramic insert is impregnated by the liquid cast metal and the ceramic particles are completely embedded in this way in the metal matrix. This impregnation leads to a substantially pore-free composite structure on the working face of the segment. Such a detailed structure is represented in FIG. 5.

### EXAMPLE

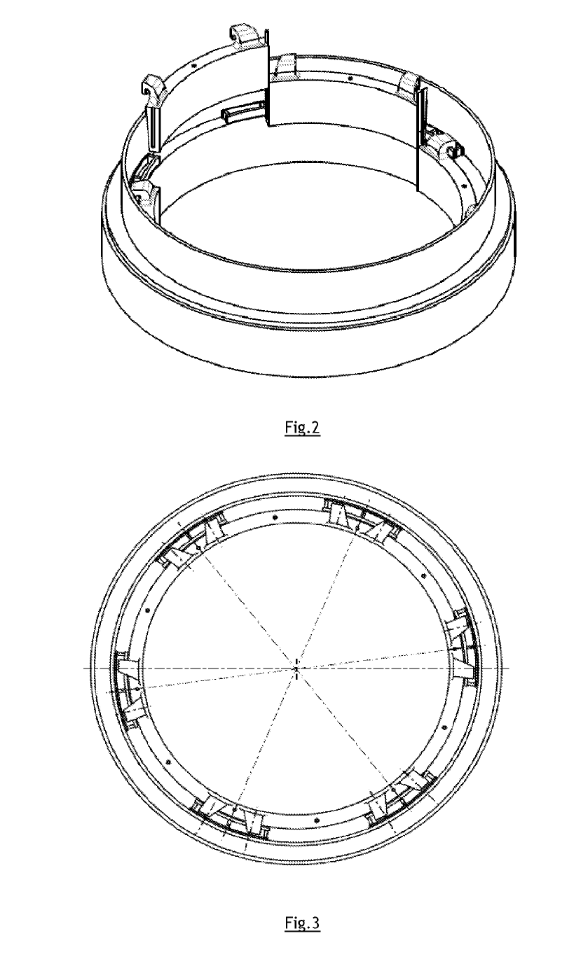

A grinding ring with 6 segments and with a diameter of about 1.6 meters is assembled via pin rods and shims. Each segment comprises hangers cooperating with specific holes in the supporting ring of the grinding mill (see FIG. 2).

Each segment comprises in this case a reinforced composite wear layer of about 20 mm. The wear layer is reinforced by granules (0.5 to 5 mm) of a ceramic composite of alumina-zirconia (57 wt % Al2O3-43 wt % ZrO2) from which a compacted insert is placed in the mould before the segment is cast at about 1500° C.

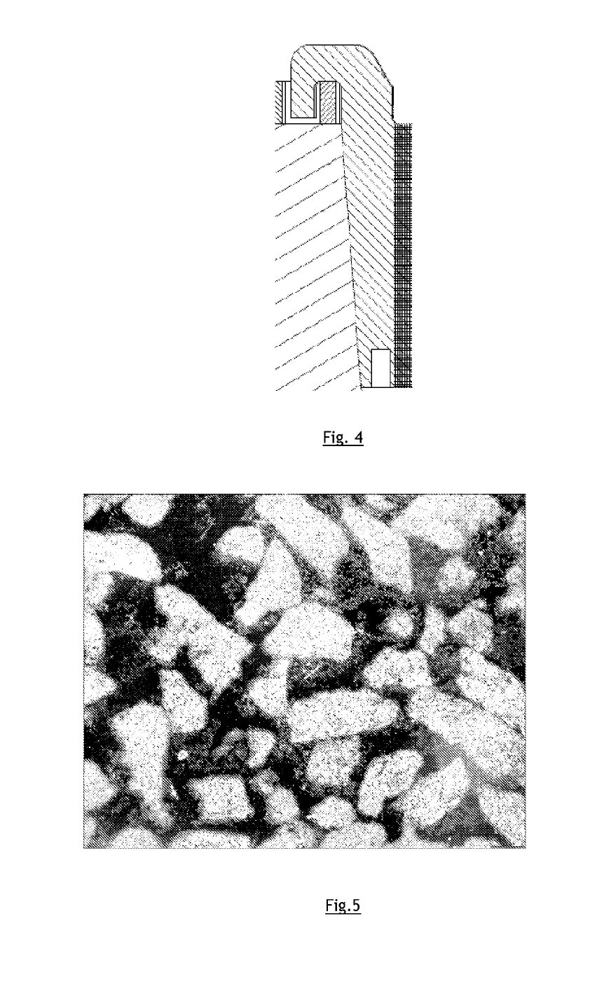

The result of this pouring operation is represented in FIG. 4. A reinforced wear layer of about 20 mm thickness is achieved on each individual segment.

After the casting of each of the six segments, a grinding ring according to the invention is assembled. Each segment comprises a recess for a positioning pin to be placed between each couple of segments. This type of assembling allows maintaining the segments by vaulting effect.

1. Segmented grinding ring for centrifugal vertical roller mills comprising a plurality of segments.

2. Segmented grinding ring according to claim 1 , wherein said segments comprise a composite structure on their working face, said composite structure comprising ceramic particles embedded in a cast metal.

3. Segmented grinding ring according to claim 1, wherein the thickness of the composite structure comprising the embedded ceramic particles is at least 10 mm, preferably at least 20 mm.

4. Segmented grinding ring according to claim 1, wherein the thickness of the composite structure comprising the embedded ceramic particles is between 20 and 30 mm.

5. Segmented grinding ring according to claim 1, wherein the composite structure comprising the embedded ceramic particles is a honey comb structure.

6. Segmented grinding ring according to claim 1, wherein the ceramic particles are selected from the group consisting of metallic oxides, metallic carbides, borides and nitrides.

7. Segmented grinding ring according to claim 1, wherein the ceramic particles are selected from the group consisting of Al₂O₃ , ZrO₂, Al₂O₃—ZrO₂, WC, TiC, SiC, B₄C, BN and Si₃N₄.

8. Segmented grinding ring according to claim 1, wherein the ceramic particles are spheroid ceramic grains of a size between 0.5 to 6 mm, said grains comprising an alumina-zirconia composite comprising 20 to 80 wt % ZrO₂ and 80 to 20 wt % Al₂O₃.

9. Segmented grinding ring according to claim 1, wherein the ceramic particles are spheroid ceramic grains of a size between 1 and 5 mm, said grains comprising an alumina-zirconia composite comprising 35 to 45 wt % ZrO₂ and 65 to 55 wt % Al₂O₃.

10. Segmented grinding ring according to claim 1, wherein said ring presents 3 to 12 segments, preferably 4 to 6 segments.

11. Segmented grinding ring according to claim 1, wherein said segments comprise a recess for the introduction of a positioning pin located between each couple of segments, said segments being maintained connected to each other by vaulting effect.

12. Segmented grinding ring according to claim 1, wherein said segments comprise hangers to maintain the segments during the mounting operation.

13. Segmented grinding ring according to claim 1, wherein said ring comprises shims to close possible gaps between the segments after the mounting operation.

14. Centrifugal vertical roller mill comprising a segmented grinding ring according to claim 1.
